(19) United States
(12) Patent Application Publication
(10) Pub. No.: US 2026/0101267 A1
(43) Pub. Date: Apr. 9, 2026

(54) APPLICATION LAYER SUPPORT FOR NO-TRANSMIT ZONE ENFORCEMENT

(71) Applicant: InterDigital Patent Holdings, Inc., Wilmington, DE (US)

(72) Inventors: Taimoor Abbas, Sainte-Julie (CA); Samir Ferdi, Kirkland (CA); Michel Roy, Candiac (CA); Jung Je Son, Warrington, PA (US); Guanzhou Wang, Brossard (CA); Anuj Sethi, Ottawa (CA); Atle Monrad, Froland (NO)

(73) Assignee: InterDigital Patent Holdings, Inc., Wilmington, DE (US)

(21) Appl. No.: 18/905,597

(22) Filed: Oct. 3, 2024

(51) Int. Cl. H04W 48/04; G08G 5/00; H04W 52/28

(52) U.S. Cl. CPC H04W 48/04; G08G 5/34; H04W 52/283

(57) ABSTRACT

Systems, methods, and instrumentalities for application layer support for no-transmit zone (NTZ) enforcement. An example a network node may be used for supporting NTZ enforcement. The network node may determine a cell in which NTZ enforcement applies, and coordinates of an NTZ area, wherein the cell is associated with the NTZ area. The network node may determine an NTZ policy, where in the NTZ policy is associated with the NTZ area. The network node may send, to a wireless transmit/receive unit (WTRU), NTZ configuration information that indicates the cell in which NTZ enforcement applies, the coordinates of the NTZ area, a transition area, the NTZ area, and one or more parameters associated with the NTZ enforcement. The network node may receive, from the WTRU, a notification that indicates that the WTRU is out of the NTZ area.

### BACKGROUND

Mobile communications using wireless communications continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein for application layer support for no-transmit zone enforcement. An example device may include a processor configured to perform one or more actions.

An example network node may be used for supporting no-transmit zone (NTZ) enforcement. The network node may determine a cell in which NTZ enforcement applies, and coordinates of an NTZ area, wherein the cell is associated with the NTZ area. The network node may determine an NTZ policy associated with the NTZ area. The network node may send, to a wireless transmit/receive unit (WTRU), NTZ configuration information that indicates the cell in which NTZ enforcement applies, the coordinates of the NTZ area, a transition area, the NTZ policy and one or more parameters associated with the NTZ enforcement. The network node may receive, from the WTRU, a notification that indicates that the WTRU is out of the NTZ area.

The one or more parameters associated with the NTZ enforcement may include at least one of: a level of transmission blocking within the cell, an indication to reduce transmission power while in the transition area, an indication to search for communication paths permitted for use while in the NTZ area, an indication to update a flight path to avoid the NTZ area, a condition on which to report cell information associated with the cell, or whether the NTZ area has geographic restrictions, frequency restrictions, and/or time restrictions.

The one or more parameters associated with the NTZ enforcement may include at least one of a level of transmission blocking, full transmission blocking, partial transmission blocking, or occasional transmission blocking.

The network node may receive an NTZ management request that indicates NTZ requirements and a list of WTRUs to send the NTZ configuration information, wherein the list of WTRUs comprises the WTRU. In response to sending the NTZ configuration information, the network node may send an NTZ management response that indicates that the NTZ configuration information was provided to the WTRU.

The network node may receive a report from the WTRU while the WTRU is in the NTZ area. The report may be received over a communication path permitted for use while in the NTZ area. The network node may receive an NTZ support capability from the WTRU during a registration procedure. The network node may receive an indication that the WTRU received the NTZ configuration information.

A network node may be used for providing a flight route that avoids a no-transmit zone (NTZ). The network node may receive, from a wireless transmit/receive unit (WTRU), a registration message. The network node may receive, from the WTRU, a flight route request. The flight route request may include an indication to avoid the NTZ. The network node may determine a flight route for the WTRU. The flight route may include at least a waypoint that is outside the NTZ. The flight route may avoid the NTZ. The network node may send, to the WTRU, a flight route response message. The flight route response message may include an indication of the flight route.

The network node may determine at least one of an NTZ coordinate or an NTZ parameter. The network node may determine the flight route for the WTRU using at least one of the NTZ coordinate or NTZ parameter. The network node may determine the flight route for the WTRU using at least one of an end point, a network coverage, or an NTZ coordinate.

The network node may determine an NTZ capability associated with the WTRU based on the registration message.

The network node maydetermine a WTRU coordinate that indicates a location associated with the WTRU. The network node may determine one or more NTZ coordinates that are associated with the NTZ. On a condition that the flight route request comprises the indication to avoid the NTZ, the network node may determine a restricted area indicated by one or more NTZ coordinates. The network node may determine the waypoint is outside of the restricted area. The network node may generate the flight route for the WTRU using at least the WTRU coordinate and the waypoint.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example no-transmit zone mapping.

FIG. 3 illustrates an example uncrewed aerial system (UAS) application layer model.

FIG. 4 is a flow diagram illustrating signaling for enabling an application layer for no-transmit zone enforcement.

FIG. 5 is a flow diagram illustrating signaling for providing a flight route to avoid a no-transmit zone.

### DETAILED DESCRIPTION

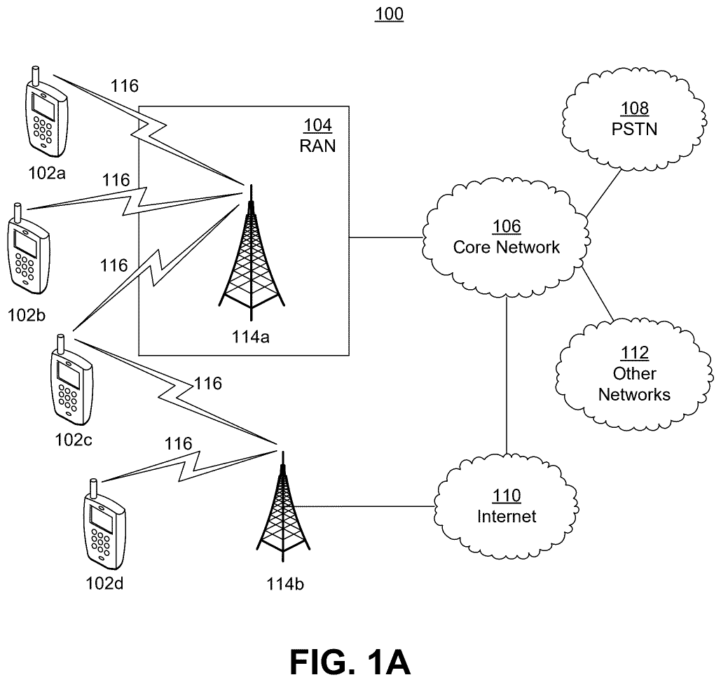

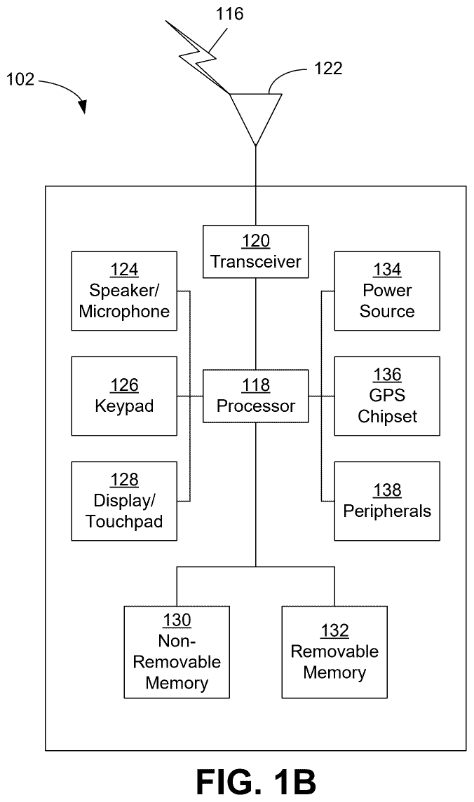

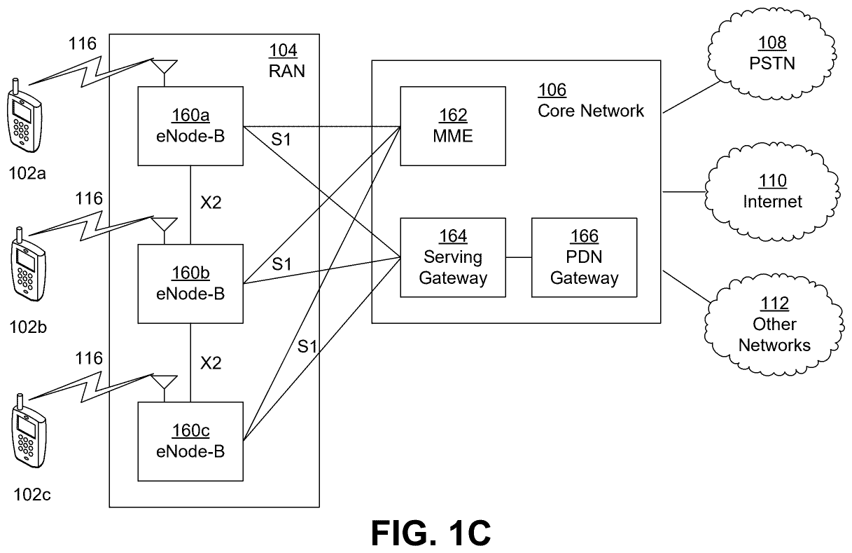

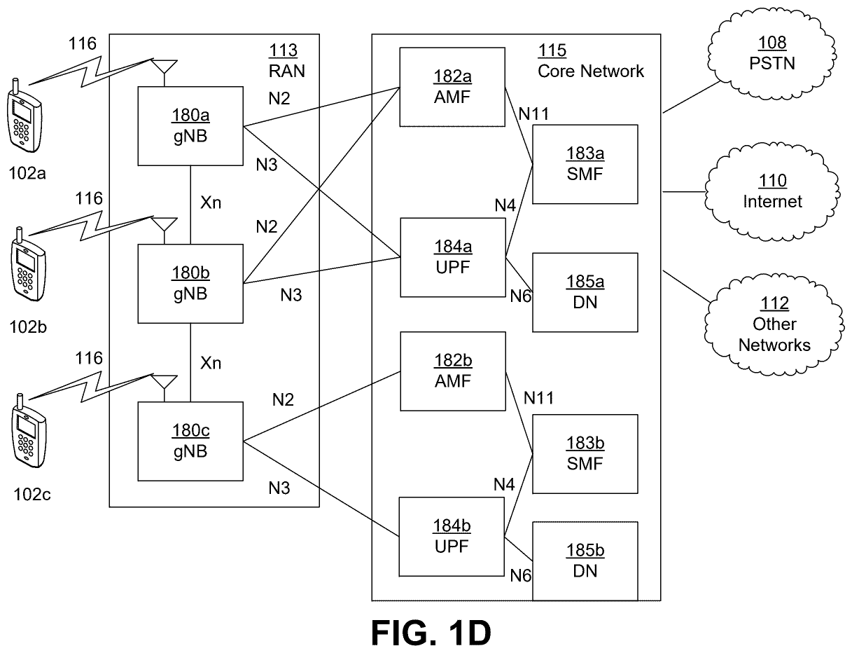

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

The following acronyms are used herein:

| | |
|---|---|
| 5GS | 5G System |
| A2X | Aircraft-to-anything |
| AMF | Access and Mobility Management Function |
| API | Application Programming Interface |
| BVLOS | Beyond Visual Line of Sight |
| CAA | Civil Aviation Authority |
| CGI | Cell Group Identity |
| DAA | Detect And Avoid |
| GS | Ground Station |
| NAS | Non-Access Stratum |
| NEF | Network Exposure Function |
| NTZ | No-Transmit Zone |
| NW-DAA | Network-assisted or ground-based mechanism for DAA |
| RDV | Rendezvous |
| RID | Remote Identification |
| SEAL | Service Enabler Architecture Layer |
| UAS | Uncrewed Aerial System |
| UAS NF | UAS Network Function |
| UAV | Uncrewed Aerial Vehicle |
| Uu | The air interface between UE (e.g., a WTRU) and |
| | radio access network (e.g., a 3GPP radio access network) |
| WTRU | Wireless Transmit/Receive Unit |

PC5 may refer to the reference point between ProSe-enabled WTRUs used for control and user plane for 5G ProSe Direct Discovery, 5G ProSe Direct Communication, and 5G ProSe WTRU-to-Network Relay.

Feature(s) associated with no-transmit zone(s) are provided herein.

Feature(s) associated with harmonized technical conditions for mobile/fixed communication networks (MFCN) bands and for spectrum compatibility purposes are provided herein. Spectrum operational restrictions may be defined. Restrictions may be implemented using no-transmit zones (NTZ). NTZ may refer to a geographical area where aerial WTRUs are not allowed to operate in a certain frequency band. Out-of-band (OOB) emission limits specific to aerial WTRU may be defined (e.g., to avoid interference to other services in some other bands, for example, to protect a Meteorological Satellite (MetSat) at 1675-1710 MHZ). These limits (e.g., requirements) may apply to aerial WTRUs according to their operational frequency band (e.g. aerial WTRUs operating in a specific band or specific channel). In some examples, operation of aerial WTRUs may involve (e.g., require) respective cross-border coordination agreements.

A no-transmit zone may refer to a geographical area where aerial WTRUs are not allowed to transmit for spectrum compatibility purposes (e.g., in a given harmonized MFCN band or part of it). An NTZ may be a five-dimensional area. The five dimensions may include three-dimensional restrictions (e.g., length, width, height), and two-dimensional restrictions in frequencies and time. An NTZ may be a geographical area that can map to one or more cells, a fraction of a cell, or overlap different cells in a mobile operator network.

National studies may be performed (e.g., as appropriate) to define no-transmit zones for spectrum compatibility purposes (e.g., for aerial WTRU operating in the relevant frequency bands). A mechanism may be used to ensure that aerial WTRUs respect no-transmit zones.

Feature(s) associated with enforcing the no-transmit zone are provided herein.

Standard(s) may control support for UAV connectivity for LOS (line-of-sight) and BVLOS (beyond-LOS) scenarios. Standard(s) may determine whether and how to support the enforcement of NTZs for a UAV.

NTZ enforcement may apply to a WTRU that is a UAV WTRU (e.g., an aerial WTRU) with an aerial subscription. NTZ enforcement by a UAV WTRU may apply for LTE and NR. Transmissions in the restricted frequency bands may not be allowed from a UAV WTRU that is located in the NTZ (e.g., regardless of the service type).

Existing tracking areas and cells may not be replanned based on the presence of NTZs. NTZ mapping to cells may not impact specifications (e.g., may be WTRU implementation specific).

Assistance information may be (pre-) configured in the UAV or sent over the application to the UAV. UAV WTRUs supporting NTZ regulations may be configured with NTZ assistance information. The assistance information may allow these UAV WTRUs to be aware of the presence of NTZs.

Transmissions in the restricted frequency bands may not be allowed from a UAV WTRU located in the NTZ (e.g., in five dimensions to consider three-dimensional restrictions, frequencies, and time). Transmissions in the restricted frequency bands may not be allowed from a UAV WTRU located in the NTZ regardless of the service type. UAV WTRU may not transmit or attempt to transmit in the NTZ. UAV WTRUs may transmit/receive (e.g., normally) outside of the NTZ.

The RAN may not be impacted by NTZs. The RAN network may not be involved in the process of informing the WTRU about no-transmit zone(s). The RAN network may not be involved in the process of enforcing WTRU behavior within the NTZ(s). The WTRU may be responsible for following any applicable NTZ(s) regulations. The RAN network may not receive information associated with the NTZ(s).

Example NTZ scenario considerations are described herein.

An NTZ may have five-dimensional (5D) area restrictions (e.g., including three-dimensional geographical area (length, width, height) and restrictions based on frequencies and time). Transmissions may not be allowed from a WTRU (e.g., UAV WTRU) in the restricted frequency bands and time if the WTRU is located within an NTZ area (e.g., regardless of the service type). If a transmission on a frequency band is blocked, radio waves propagating on that frequency band will likely not reach a receiver located in an NTZ or interfere (e.g., above a certain threshold) with other communications in an NTZ. Blocking the radio wave on a frequency band at the edge of an NTZ or inside the NTZ may not guarantee that the NTZ requirements are fully enforced. Radio signals transmitted from outside an NTZ may be powerful enough to make an impact inside the NTZ.

A WTRU, based on the GPS location, may know that it is located within an NTZ and may stop transmission. Other WTRUs located outside the NTZ area may still be interfering. An NTZ with a clear boundary (e.g., fine granularity) may not be sufficient. The radio propagation impact and cellular coverage map may be considered when defining an NTZ.

If a WTRU (e.g., a UAV WTRU) is using GPS coordinates to determine whether the WTRU is in an NTZ, the WTRU may keep track of its location. Frequent location updates may drain the battery. NTZ enforcement based on the tracking area and cell ID may be efficient in terms of power. The NTZ may map to one or more cells, a fraction of a cell, or overlap different cells in a mobile operator network. The NTZ may block the transmissions in a cell (e.g., each of the cells) that has full or partial mapping to an NTZ.

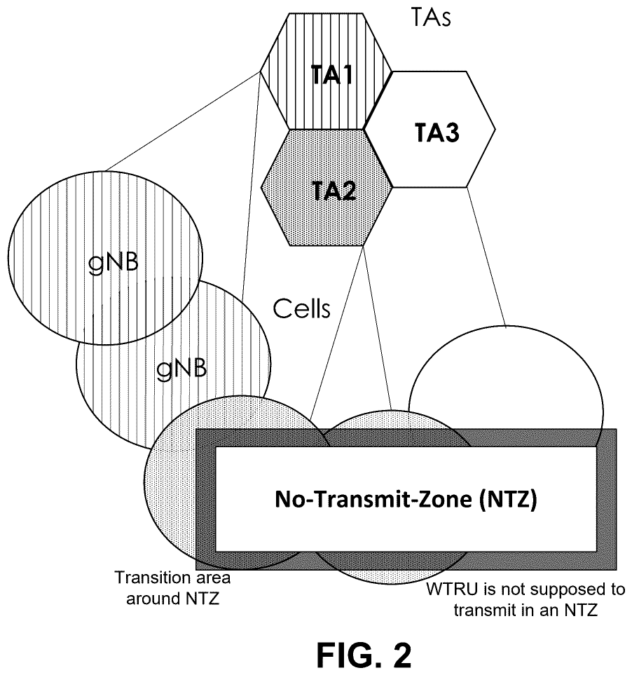

FIG. 2 illustrates an example no-transmit zone mapping to cell coverage area.

The radio wave propagation may depend on one or more factors. The factors may include the transmission power, propagation environment, antenna pattern, beam directivity, etc. In cellular systems, these factors may be known by the cellular network (e.g., gNB). A WTRU may not be aware of these details. A WTRU may not be able to map cell coverage to an NTZ. A WTRU may have information (e.g., Cell Group Identity (CGI), which may include PLMN ID and Cell ID) and parameters (e.g., Physical Cell ID, Serving Cell Info, Tracking Area (TA) List, TAC, RA) if the WTRU has cellular service.

The TAs may not correspond to the physical size or dimensions of individual cells. The TAs may include many cells within a larger geographic area. Cell dimension or physical coverage area may depend on one or more factors (e.g., which may be known only to the gNB). A TA may refer to a logical grouping of multiple cells. A TA may be used for managing mobility across groups of cells. The physical dimensions of a cell may be specific to the cell itself (e.g., not part of the TA or RA). A cell of a mobile network may be part of a (e.g., single) TA. A TA may be composed of several cells.

Feature(s) associated with UAV flight route tracking are provided herein. UAV flight route tracking may be used by UAS applications (e.g., for BVLOS missions or UAVs that navigate autonomously). Mechanisms may enable the UAV location tracking or flight route monitoring through a network (e.g., the 3GPP cellular network).

The network may provide UAV tracking information to an USS (e.g., via a network exposure function or a UAS NF). One or more tracking modes may be supported. For examples, in a UAV location report mode, the UAS NF may initiate locations services (e.g., a 3GPP location service procedure) to obtain the UAV's location information. The UAS NF may report the UAV's location information to the USS. In a UAV presence monitoring mode, the network may monitor whether the UAV shows up in a monitoring area. The UAV may report the presence information to the USS.

Location deviation monitoring may be performed using a SEAL Location Management Server. The SEAL Location Management Server may fetch the location information (e.g., from the 5GC or from the application client). The SEAL Location Management Server may determine whether the client is inside or outside an area of interest. The SEAL Location Management Server may report the location information back to the application server. This technique may be used for monitoring whether an UAV has deviated from its planned flight route.

Support (e.g., 5GS support) for UAS applications may be improved. Information may be provided to a USS to enhance flight monitoring and control, flight route management, etc.

An example UAV Application Enabling (UAE) framework is provided herein.

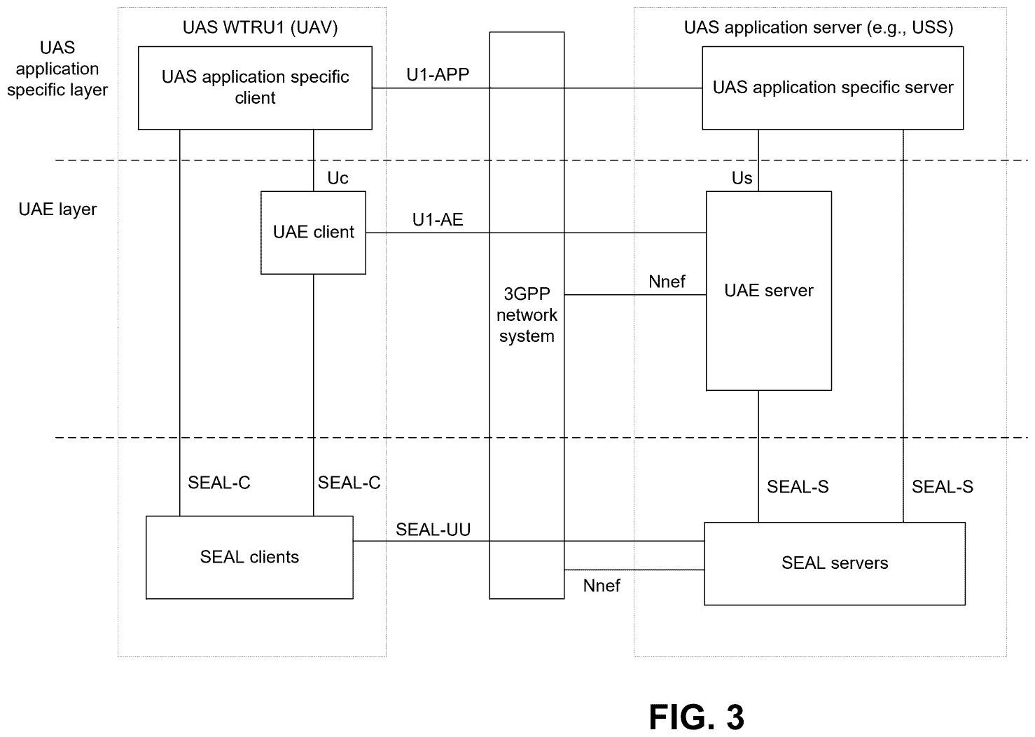

A framework may be used to support UAV applications. FIG. 3 illustrates an example (e.g., simplified) UAS application layer functional model. A UAE client (e.g., that resides in the WTRU) may provide an API to a UAS client application. The UAE client may interface with a UAE server. The UAE server may provide an API to a UAS server application (e.g., USS). The UAE server may interface with the system, such as a 5GC (e.g., directly, via a Network Exposure Function (NEF) API, or via Service Enabler Architecture Layer (SEAL) services).

A WTRU (e.g., a UAV) may use GPS coordinates to determine whether the WTRU is in an NTZ. The WTRU may determine whether to transmit based on the GPS coordinates. The WTRU may use GPS coordinates to determine whether the WTRU is in an NTZ if (e.g., only if) the NTZ is a clearly defined area (e.g., with a fine granularity), and the NTZ enforcement is applied like an on/off switch (e.g., no transmissions inside the NTZ, and transmissions allowed outside the NTZ). If the GPS-based approach is adopted, the UAV may rely on (e.g., only on) the WTRU's location to enforce the NTZ. The GPS-based approach may not always work for one or more reasons.

For example, the NTZ may not be a clearly defined area (e.g., with a fine boundary). The NTZ enforcement based on geographical location (e.g., only geographical location) may not be sufficient to enforce NTZ for cellular systems (e.g., because of frequency and radio dependency). A cellular network may use a cell coverage map and WTRU location information to enforce NTZ. A global navigation satellite system (e.g., GPS, Galileo) may lack sufficient precision in certain conditions (e.g., dense urban areas, canyons). The location reported by the WTRU's onboard system may be unreliable without usage of complementary network assisted positioning.

The WTRU may know the cell ID and tracking areas (TAs). The WTRU may not be aware of mappings between the cell ID and/or TAs to an NTZ (e.g., because the cell ID and TAs may not contain geographical dimensions or the coverage map).

Entities located outside the 3GPP network (e.g., such as the Application Functions (AF), a USS, or an NTZ server) may have access to UAV flight path information and/or NTZ information. These entities may not have access to the cell-related information of the mobile network. These entities (e.g., an AF) may not be able to map the NTZ to the geographical dimensions or the coverage map to serving cells. The cell information of the mobile network may be kept within the MNO domain (e.g., because the cell information may be sensitive information that is rarely shared).

The replanning of tracking areas and cells based on the presence of NTZs may not be considered. The NTZ may be mapped to the available cells. It may be important to correctly map NTZs to the existing cells.

The network and/or WTRU may determine the cells/TAs in which no transmission restrictions apply. If the WTRU cannot map an NTZ to cell IDs or tracking areas, the WTRU may not know where the NTZ is applicable. In this case, NTZ specifications/requirements may not be enforced (e.g., may not be enforced at all or enforced correctly).

Techniques for applying the NTZ enforcement to the relevant WTRUs (e.g., UAVs) are provided herein.

NTZ information may be correlated with related network coverage areas (e.g., cell id). A WTRU may use the NTZ information and correlation to enforce corresponding no-transmission restrictions. An entity (e.g., an NF or a WTRU) may translate NTZ and correlate with the network specific identifiers (e.g., Cell ID, Tracking Area etc.). The WTRU may receive the NTZ related information. The WTRU may use the NTZ information to enforce an NTZ. A USS and/or an NTZ responsible management entity may control NTZ compliance of UAVs.

A WTRU may not be able to map the NTZ area to cell IDs or Tas (e.g., because the WTRU doesn't have the physical dimension of a cell or a TA). Techniques for mapping the NTZ to a cell/TA are provided herein. The mapping may be performed in the UAV and/or in the network. The UAE server may assist the UAV in flight path planning (e.g., to avoid the NTZ as much as possible). The UAE-layer support may provide an added value. The UAE-layer support may secure controlled behavior (e.g., on top of or based on the provided policies).

A UAE server may provide NTZ assistance information and policy information to a WTRU (e.g., a UAV). The WTRU may use the assistance information and policy information to prepare for the NTZ enforcement (e.g., before entering the NTZ), for enforcing the NTZ (e.g., while it is inside the NTZ), and a policy for re-establishing a connection (e.g., once the WTRU is outside the NTZ).

A UAE server may use the NTZ information for flight path planning. For example, the UAE server may suggest the flight routes for a UAV that avoid NTZ exposure.

An application layer may provide support for NTZ enforcement.

A UAE client (UAE-C) may refer to a UAS application enabler client in the UAV (e.g., a WTRU). The terms WTRU, UAV, or UAE client may be used interchangeably herein.

A UAE server (UAE-S) may refer to a UAS application enabler server located in a network (e.g., the 3GPP network). The network may be managed by the network operator.

A USS may refer to a UAS service supplier server located outside the network (e.g., the 3GPP network). The USS may be managed by a third party.

The UAE server may perform one or more of the following actions. The UAE server may receive NTZ support capability from the WTRU (e.g., when WTRU performs registration or registration update). The UAE server may receive an NTZ management request from the USS (e.g., including the NTZ requirements and a list of UAVs).

The UAE server may coordinate (back and forth via an NF, for example, an NEF) with the core network to locate areas in the wireless network that correspond to the NTZ area. The UAE server may receive cell IDs, TA information, and/or the like that are relevant to the NTZ coordinates.

The UAE server may construct NTZ assistance information for a WTRU. The NTZ assistance information may include the cell IDs/TAs in which NTZ enforcement applies, the transition area, and/or the NTZ coordinates.

The UAE server may construct an NTZ policy for a WTRU. The NTZ policy may include instructions for a UAV (e.g., to interpret full, partial, or occasional transmission blocking within a cell or TA, to look up for alternative communication paths, to understand the transition area and how to make use of it, etc.).

The UAE server may bundle the information as NTZ configuration information. The NTZ configuration information may include NTZ assistance information and/or the NTZ policy. The UAE server may send the NTZ configuration information to the UAVs. The UAVs may use the NZT configuration information to enforce the NTZ.

The UAE server may send an NTZ management response to the USS. The NTZ management response may notify the USS that the NTZ configurations have been provided to the UAVs.

The UAE server may receive a report from the UAE-C(e.g., over any available communication path permitted to communicate while in the NTZ), for example, while in the NTZ.

The UAE server may receive a notification from the UAE-C(e.g., when then WTRU is out of the NTZ).

The WTRU (e.g., a UAV) may perform one or more of the following actions. The WTRU may send NTZ support capability information to a UAE server or a USS (e.g., upon registration or registration update). The WTRU may receive NTZ configuration information from the UAE server. The WTRU may pass the configuration information to the lower layers (e.g., using the AT commands). The WTRU may implement the NTZ enforcement. The WTRU may report to the UAE server according to the NTZ policies.

The UAE server may provide flight routes to avoid NTZ(s). The UAE server may perform one or more of the following actions. The UAE server may receive NTZ support capability from the UAE-C when UAE-C performs registration or registration update.

The UAE server may receive a flight route request. The flight route request may include an indication to avoid NTZ (e.g., by sending an “Indication to Avoid NTZ”). The UAE server may receive NTZ requirements. The UAE server may request NTZ requirements from the NTZ server or from the USS (e.g., upon reception of flight route request).

The UAE server may (e.g., upon reception of a request to avoid NTZs) use NTZ coordinates as a restricted area for flight route planning. The UAE server may look up flight routes that avoid NTZs. Based on the search, the UAE server may pick a route (e.g., the best available route) for the UAV. The UAE server may send, to the entity that has sent the request (e.g., WTRU, UTM, UAV, or UAV-C), a flight route reply with the selected waypoints.

If the suggested route does not avoid NTZs, the UAE server may provide an indication that NTZs were not avoided (e.g., Result=Failure {Indication to avoid NTZ}). If the result is a Failure, the UAV may enforce NTZ rules as proposed herein.

The application layer may support NTZ enforcement. A UAE server may help the UAV enforce NTZ requirements.

In an example phase, such as in a first phase, the UAE server may prepare a UAV (e.g., so the UAV is ready to enforce NTZ requirements, for example, as soon as they are applicable). A UAE server may construct NTZ assistance information and an NTZ policy (e.g., based on the information received from an NTZ server or from the USS). The UAE server may send the NTZ assistance information and the NTZ policy to the WTRU (e.g., UAE server sends the information to the UAE client).

In an example phase, such as in a second phase, the UAE client may push the NTZ assistance information from the higher layers to the lower layers (e.g., using AT commands, and implementing the logic on the lower layer). The UAV may keep track of its location geographically and/or the tracking areas. If the UAV identifies that the UAV is close to an NTZ or inside an NTZ, the UAV may enforce the requirements based on the NTZ assistance information and the NTZ policy.

In an example phase, such as in a third phase, the WTRU may be inside the NTZ (e.g., cannot transmit on the blocked frequency bands). The UAV may monitor its location and/or the tracking area (e.g., by reception only or a transmission on alternate bands) to determine when and where the requirement for NTZ enforcement is not applicable. The UAV may use other means (e.g., non-3GPP connection, PC5 connection, etc.) to maintain its connection with the UAE server/USS (e.g., to report the UAV's location). The UAE may re-establish a connection with the USS (e.g., as soon as it is out of the NTZ) for example, based on the received policy.

There may be an area before an NTZ restricted area where a WTRU prepares itself for NTZ enforcement. Such an area may be referred to as the transition area for the NTZ (e.g., as shown in FIG. 2). The transition area may have one or more of the following characteristics.

The transition area may be an area where the NTZ enforcement is not applicable. In the transition area, the WTRU may prepare itself for NTZ enforcement (e.g., reducing the transmission power, adopting the policies provided by the network, or determining alternatives that are available while the NTZ is enforced such that an application layer connectivity could be maintained with the USS, etc.).

The transition area may be an area bigger than the NTZ in length, width, and/or height (e.g., an area fully surrounding the NTZ in 2D or 3D).

The transition area may be an area that is fixed or dynamic. Whether the transition area is fixed or dynamic may be defined by the network (e.g., UAE server).

The transition area may be an area that corresponds to a list of tracking areas (e.g., all the tracking areas which are fully or partially touched by an NTZ), or cell IDs (e.g., all the cells which are fully or partially touched by an NTZ).

Feature(s) described herein may enable application layer support for a UAE client for NTZ enforcement.

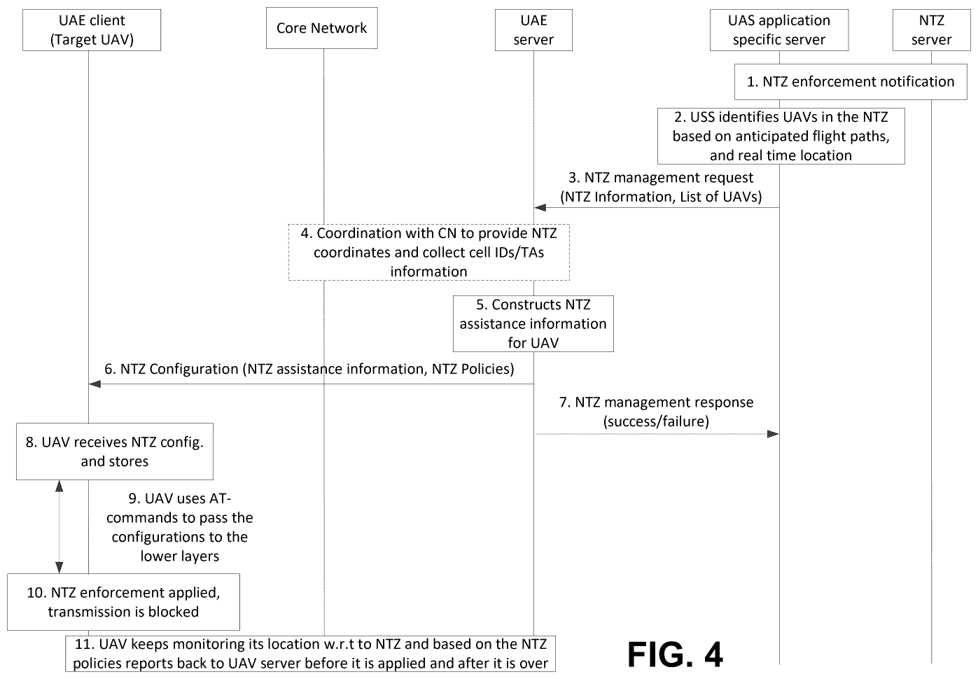

FIG. 4 is a flow diagram illustrating signaling for enabling an application layer for no-transmit zone enforcement.

The application function (AF) or NTZ server may notify the USS about the NTZ requirements. The NTZ requirements may include the five-dimensional NTZ information (e.g., three-dimensional restrictions including length, width, height, and two-dimensional restrictions in frequencies and time). The NTZ information may be received by the USS, from one or more NTZ server(s).

The functionality of the NTZ server and the USS may be combined such that the USS may be aware of the NTZ requirements. The USS may request the NTZ requirements from an NTZ server based on a planned flight path.

The USS may determine a list of UAVs that are registered with the USS (e.g., based on the 3D location and time) and that may be impacted because their real time location or planned flight paths may overlap with the NTZ enforcement area. The USS may construct a list of UAVs to be notified of the NTZ requirements (e.g., a list of CAA-level UAV IDs).

The UAE server may receive an NTZ management request from the USS. The NTZ management request may include one or more of the following.

The NTZ management request may include the identifiers of one or more UAVs (e.g., CAA-level UAV IDs of the UAVs) that are in the NTZ designated area identified by the USS. The request may apply to the (e.g., all the) UAVs controlled by the USS. In an example, the UAE server may identify the (e.g., all the) corresponding UAVs belonging to the requesting USS. The UAE server may ask the USS for the list of UAVs. The UAE server may extract the list of UAVs from the information previously stored within the UAE server.

The NTZ management request may include the NTZ requirements related to one or more NTZ enforcement areas (e.g., as received at 1 in FIG. 4).

The NTZ requirements may indicate (e.g., for one or more NTZs) the frequency bands or spectrums on which the UAVs are not allowed to transmit. The UAVs may not be allowed to transmit (e.g., at all on any frequency). If the UAVs are not allowed to transmit on any frequency, the NTZ requirements may not specify any particular frequency bands.

The NTZ requirements may indicate (e.g., for one or more NTZs) the period during which the NTZs may apply. If no period is specified, the UAV may determine that the NTZ should be (e.g., immediately) enforced (e.g., until canceled).

The NTZ requirements may indicate (e.g., for one or more NTZs) the type of communication (e.g., C2 communication, short-range sidelink communication, etc.) that is exempted in NTZs.

The UAE server may coordinate with the core network (e.g., back and forth via a NF or a NEF) to locate areas in the wireless network that corresponds to the NTZ area (e.g., as defined in the request received at 3). Based on NTZ requirements with the CN, the UAE server may receive (e.g., from the CN) cell IDs, TAs information, and/or the like that are relevant to the NTZ coordinates.

In some deployment examples (e.g., scenarios), the CN may not be able or authorized to provide the cell ID and/or TA information to the UAE server. The UAE may have a capability for collecting the cell ID and/or TA information from reports sent by UAV to the UAE server based on present and/or past flights. Over time, a UAE server may be able to collect information to construct a network map in proximity to NTZ zones for the purposes of NTZ enforcement.

The UAE server may determine if the CN has the capability of providing cell ID and/or TA information. The UAE server may determine if the UAE clients should report the detected cell ID and/or TAs in proximity to an NTZ. The determination of CN support may be based on the availability of a CN API, or a response sent by the CN (e.g., when invoking such CN API). Requesting the UAE client to report cell ID and/or TA information in proximity to an NTZ may be communicated to the UAE client with the NTZ policy (e.g., as described at 5 and 6). The cell ID and/or TA information may be reported back to the UAE server (e.g., at 11).

An API may (e.g., may be defined to) allow a UAE server to obtain cell IDs and TA information from the CN (e.g., which may be managed by the network operator or the service provider).

The UAE server (e.g., upon reception of network specific parameters) may perform one or more of the following actions.

The UAE server may identify relevant UAVs. The UAE server may identify relevant UAVs using the list of UAVs (e.g., as provided by the USS at 3). The UAE server may identify the (e.g., all) corresponding UAVs belonging to the requesting USS (e.g., if no UAV identifiers are specified in the request). The UAE server may identify UAVs in the applicable zone that are served by a different USS.

The UAE server may construct NTZ assistance information for a WTRU. The NTZ assistance information may include the cell IDs/TAs in which NTZ enforcement applies. For a (e.g., each) TA or cell ID the NTZ assistance information may indicate whether the TA or cell ID is fully blocked, partially blocked, occasionally blocked, etc. The WTRU may use the NTZ assistance information according to a policy, as described herein.

The NTZ assistance information may indicate the transition area. The UAE server may determine the size of the transition area (e.g., the transition area that is relevant for a UAV before and after NTZ enforcement is applicable). To determine the transition area, the UAE server may consider the (e.g., all the) available information (e.g., NTZ geographical requirement, frequency, type of services currently being deployed by the relevant UAVs, location of the UAVs, etc.). The transition area may be in the form of physical coordinates or the form of cell IDs/TAs.

The NTZ assistance information may indicate the NTZ coordinates (e.g., for one or all NTZs). The NZT coordinates may be in the form of a list that includes five-dimensional NTZ information (e.g., three-dimensional restrictions, including length, width, height, and two-dimensional restrictions in frequencies and time), for example, for each NTZ.

The UAE server may construct an NTZ policy for a WTRU. A fully blocked cell ID or TA may indicate that no transmission is allowed in the (e.g., whole) cell or TA if at least part of the NTZ located inside the cell or TA.

A partially blocked cell ID or TA may indicate that the transmission in a portion of the cell or TA is blocked. The blocked portion may be in the form of geographical information, frequency bands, and/or the like. The UAV may determine where and on which bands the transmission is not permitted (e.g., based on the WTRU's GPS coordinates and/or allowed frequency bands). This approach may be applied for some (e.g., critical or emergency) services (e.g., where a complete loss of connection due to fully blocked transmission may be harmful).

An occasionally blocked cell ID or TA may indicate that the NTZ restrictions apply at specific times for the cell or the cells of the TA (e.g., marked by a start time and an end time).

The UAVs located inside the transition area may reduce transmission power (e.g., to avoid spillover in the NTZ for UAVs that are close).

The UAVs located inside the transition area or in the NTZ may try to find alternative communication paths (e.g., non-3GPP connections, for example, Wi-Fi connection, satellite connection, etc.) to avoid communication restriction.

The UAV located inside the transition area or in the NTZ may try to maneuver out of NTZ area (e.g., a UAV in the transition area may send a flight path update request to the UAE server. If authorized by the USS, the UAV may update its path to avoid the NTZ and the communication restriction.

The UAV may be allocated a timer (e.g., periodic time) that instructs a UAV to search for alternative communication paths or determine whether the UAV is out of the NTZ.

The NTZ policy may include a cell ID and TA reporting indication that instructs the WTRU to report detected cell ID and TA information (e.g., if in proximity of the NTZ). The proximity may be determined based on the NTZ coordinates. The proximity may include the transition area.

The NTZ policy may include a cell ID and TA reporting configuration that instructs the WTRU to report the detected cell ID and TA information (e.g., if new cell ID and TA are detected or on a periodic basis).

The NTZ policy may include an NTZ enforcement indication that instructs the WTRU to consider the NTZ area, the NTZ cell ID, and/or NTZ TA for enforcement of NTZ. If the policy indicates that the NTZ is area-bound, the WTRU may perform NTZ enforcement if (e.g., only if) the WTRU is in the NTZ area. If the policy indicates that NTZ is (e.g., only) network-bound, the WTRU may perform NTZ enforcement based on whether the WTRU is connected to the cell ID and/or TA. The NTZ enforcement may indicate that the NTZ uses network-bound and area-bound enforcement.

The UAE server may include the information as NTZ configuration information. The NTZ configuration information may include the NTZ assistance information and the NTZ policy. The UAE server may send the NTZ configuration information to (e.g., all) the UAVs (e.g., the UAVs identified at 5a). The UAE may perform one or more of the following actions (e.g., after the UAE server sends the NTZ configuration to the WTRU).

The UAE may provide a response to (e.g., back to) the UAE server confirming the reception of NTZ configurations.

The UAE client may (e.g., explicitly) request this information (e.g., the NTZ configuration information) from the UAE server or UAE application-specific server (e.g., via the control/user plane, for example, NAS signaling or via application layer communication between the entities).

The UAE server may send the NTZ management response to the USS. The NTZ management response may notify the USS that the NTZ configuration information has been provided to the UAVs.

The UAE server may provide the NTZ configuration information to the USS. The UAE server may provide an estimate of when UAV will enter and leave the NTZ (e.g., as there may be a “blackout” period in which the UAV stops communicating with USS/UAV-C). The USS may use the existing location area of interest mechanism with UAS NF (e.g., where the area corresponds to NTZ) to track when a UAV will stop and resume transmitting.

The WTRU may receive the NTZ configuration information from the UAE server. The WTRU may store the NZT configuration information locally in the WTRU. The WTRU may pass the NTZ configuration information to the higher layer.

The WTRU may pass the NTZ configuration information to the lower layer (e.g., using AT commands).

The WTRU may start to monitor based on the NTZ configuration information. The WTRU may apply the NTZ enforcement according to the NTZ requirements and NTZ policy. If the NTZ policy is included cell ID and TA reporting, the WTRU may monitor the broadcasted cell ID and TAs. The WTRU may report to the UAE server as requested in the NTZ policy.

The reporting may depend on the NTZ parameters. The WTRU may operate in a store and forward manner. The information included in the cell ID and TA report may include the measurement time, geolocation, and/or detected cell ID and TA from the gNodeB broadcasts.

The UAE server may build the cell ID and TA map based on UAE reports. The UAE server may re-evaluate the NTZ configuration information. The UAE server may send an NTZ configuration update (e.g., as described at 6). The NTZ configuration update may include the cell IDs/TAs in which NTZ enforcement applies.

The WTRU may keep track of its location (e.g., based on on-board GNSS unit). The WTRU may report back to the UAE server (e.g., if allowed to resume transmission according to the NTZ policies). As part of the NTZ configuration information, the UAV may be provided with a time estimate or time window indicating when the WTRU is expected to enter and leave NTZ (e.g., estimated time of arrival (ETA) in and out of the NTZ). The WTRU may determine a prediction of when WTRU will be able to stop and resume transmission (e.g., to re-enable network-assisted location tracking, USS and/or C2 communications). The time window may be determined by the USS according to flight route. For example, the WTRU may start a timer based on the time window. The WTRU may stop transmitting when entering the NTZ. The WTRU may resume transmission if the timer expires and/or the WTRU detects that it has left the NTZ (e.g., using onboard GNSS unit-based location tracking). The UAV may send a notification to the UAE server when the UAV is about to enter the NTZ. The UAV may send a notification to the UAE server when leaving the NTZ, for example, based on the NTZ time window and/or location tracking (e.g., cellular-based). The UAE server may notify the USS of the UAV entering/leaving the NTZ. The USS may use that information to determine whether the UAV network-assisted location tracking or C2 communication is suspended or available (e.g., depending on whether the UAV is flying over an NTZ).

In an example embodiment, the WTRU (UAV, UAE-client, or UAV-C) may support NTZ enforcement. The WTRU may receive NTZ configuration information and/or NTZ assistance information (e.g., from the USS or from a third-party server). The WTRU may perform at least one of the following actions. The WTRU may send NTZ capability to a UAE server (e.g., in a UAE registration procedure). The WTRU may receive a message (e.g., from the UAE server) indicating that the UAE server is to be notified of NTZ enforcement condition(s) (e.g., during a management procedure with the UAE server). The WTRU may receive application layer NTZ information. The WTRU may detect an NTZ condition (e.g., imminently while approaching the NTZ area). The WTRU may send a notification message to the UAE server to inform of the (e.g., imminent) NTZ condition(s) (e.g., by including an estimated time of arrival for NTZ (start time), and an estimated time of departure from an NTZ (end time)). The WTRU may choose to deviate from the planned flight path to avoid the NTZ. The WTRU may send a notification to the UAE server that includes the updated flight path information. The WTRU may send a notification message (e.g., to UAE server) indicating when the WTRU (e.g., UAV) gets out of NTZ.

In an example embodiment, if the WTRU supports NTZ enforcement and receives NTZ information over the application layer, the UAE server may perform at least one of the following actions (e.g., towards the WTRU or towards the USS). The UAE server may receive NTZ capability information from the WTRU (e.g., in the UAE registration procedure). The UAE server may receive a message from the USS that the WTRU may be subject to an NTZ (e.g., based on USS information the flight path goes over an NTZ). The UAE server may send a message to the WTRU indicating for the WTRU to notify the server of NTZ enforcement condition(s) (e.g., during a management procedure with the UAE server).

In an example embodiment, the UAE server may receive NTZ notification(s) from the WTRU. The UAE server may perform at least one of the following actions (e.g., towards the WTRU or towards the USS). The UAE server may update WTRU context information to include NTZ related information (e.g., start time, end time, 3D location of NTZs, etc.). The UAE server may send a notification message to the USS that the WTRU has been requested to enforce the NTZ (e.g., and may not be reachable). The UAE server may include the NTZ related information (e.g., start time, end time, 3D location of NTZs, etc.) in the notification message. The UAE server may subscribe to NTZ event notification(s) with the USS. The UAE server may subscribe to a UAE client NTZ event subscription). The UAE server may send an acknowledgment (ACK) to the WTRU to confirm receipt of the notification. The WTRU may be in an ongoing session with another WTRU (e.g., UAV controller (UAV-C)) for C2 communication. In this case, the UAE server may notify the other WTRU (e.g., UAV-C) that the WTRU will not be available. The UAE server may notify the other WTRU (e.g., UAV-C) that assistance information (e.g., dynamic C2 mode switching) by the UAE server will be paused until the NTZ condition is cleared. The UAE server may receive an “NTZ start” event from the WTRU or from the USS. The UAE server may mark the WTRU that is under NTZ condition. The UAE server may deactivate or pause the UAE services (e.g., all the UAE services) for the WTRU while the WTRU is under NTZ condition(s). The UAE server may send a notification to the USS that the status information of one or more WTRU(s) cannot be provided to the USS (e.g., because of NTZ condition). Based on the notification, the USS may initiate the procedure to unsubscribe from real-time UAV status information. The UAE server may send a message to the USS indicating that other UAE services (e.g., UAV monitoring, location tracking, detect and avoid (DAA), etc.) are paused (e.g., due to the WTRU being in NTZ mode). The UAE server may receive an NTZ end event from the WTRU or the USS. The UAE server may send a message to the USS to confirm that the UAE services have resumed.

The UAE server may provide flight routes to avoid NTZs.

Feature(s) described herein may enable the UAE server to provide a possible fight path based on a request (e.g., from UTM or UAV) that NTZs be avoided (e.g., as much as possible). The UAE layer may provide support for the flight route selection. An example procedure is explained below:

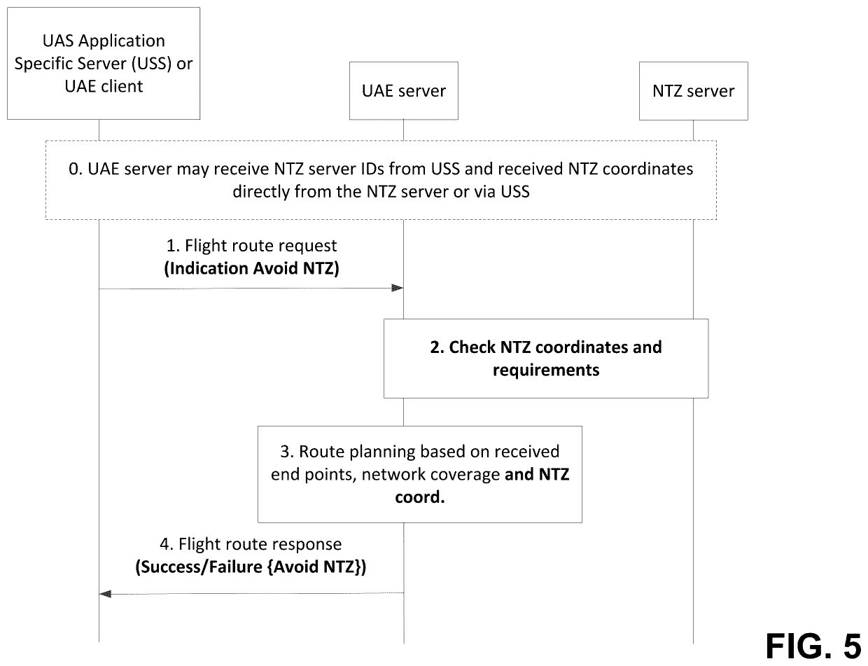

FIG. 5 is a call flow diagram illustrating signaling for providing a flight route to avoid a no-transmit zone.

At 0, the UAV may have performed the UAS WTRU registration procedure. The UAE server may be aware of the NTZ servers. The UAE server may have received NTZ requirements. The UAE server may communicate directly or via the USS.

The UAS application-specific server or UAE client (e.g., UAV or UAV-C) may send a flight route request toward the UAE server. The flight route request may include network parameters (e.g., for the specific needs of the specific use case). For example, the parameters may include a start point, destination point, times of start point and end point, QoS, link reliability, shortest route request, etc.). The UAV or USS may request that the UAE server avoid NTZs (e.g., by sending an “Indication to Avoid NTZ”).

The UAE-C may send its NTZ support capability (e.g., during registration, during registration update, during flight route request, etc.).

The UAE server may have received NTZ requirements. If the UAE server has not received the NTZ requirements, the UAE server may request NTZ requirements (e.g., from the NTZ server or from the USS). If the USS is aware of the NTZ, the UAE server may receive the NTZ information (e.g., from the USS as part of the light route request).

The UAE server may have the role of a route planning unit. The UAE server may calculate possible waypoints as geographical coordinates and specific times (e.g., based on the received end points and provisioned information). If the UAE server receives a request to avoid NTZ, the UAE server may use NTZ coordinates of a restricted area for a UAE to enter when searching for the flight routes. Based on the search, the UAE may pick an (e.g., the best) available route for the UAV.

The UAE server may send a flight route reply with the selected waypoints (e.g., selected at 3) to the entity that sent the request (e.g., UTM, UAV, or UAV-C). If the UAV is unable to avoid NTZ, the UAE server may provide an indication of whether the NTZ was avoided (e.g., using a success/failure indication to avoid NTZ). If the result is failure, the UAV may enforce the NTZ, as described herein (e.g., where applicable).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising:
a processor, wherein the processor is configured to:
determine non-transmit zone (NTZ) configuration information;
determine that the WTRU is approaching an NTZ area;
send, to a network node, a first notification message that indicates that the WTRU is approaching the NTZ area and a first time associated with entering the NTZ area;
apply an NTZ enforcement based on the NTZ configuration information upon entering the NTZ area;
determine a second time associated with the WTRU leaving the NTZ area; and
send, to the network node, a second notification message indicating a second time associated with leaving the NTZ area.

22. The WTRU of claim 21, wherein the processor is configured to determine the NTZ configuration information by sending a registration request message to the network node, wherein the registration request message indicates an NTZ support capability.

23. The WTRU of claim 21, wherein the processor is configured to determine the NTZ configuration information by sending a request message to the network node, wherein the request message indicates a request for an NTZ policy from the network node.

24. The WTRU of claim 21, wherein the processor is further configured to send an NTZ configuration response message to the network node, wherein the NTZ configuration response message indicates that the NTZ configuration information was received.

25. The WTRU of claim 21, wherein the network node is associated with NTZ enforcement, wherein the processor is configured to determine the NTZ configuration information comprises the processor being configured to receive a configuration message from the network node, and wherein the configuration message indicates at least one of the NTZ configuration information, an identifier associated with the WTRU, an identifier associated with a UAV, a cell in which NTZ enforcement applies, an NTZ area, a transition area, an NTZ policy, a restricted frequency, or a time period.

26. The WTRU of claim 25, wherein the configuration message further indicates one or more parameters associated with the NTZ enforcement, wherein the one or more parameters comprise at least one of: an indication of transmission blocking within a cell, an indication to reduce transmission power while in a transition area, an indication to search for communication paths permitted for use while in the NTZ area, an indication to update a flight path to avoid the NTZ area, or a condition on which to report cell information associated with the cell.

27. The WTRU of claim 21, wherein the configuration message further indicates one or more parameters associated with the NTZ enforcement, wherein the one or more parameters comprise at least one of: an indication of transmission blocking, full transmission blocking, partial transmission blocking, or occasional transmission blocking.

28. The WTRU of claim 21, wherein the processor is further configured to:
send an NTZ management request that indicates an NTZ requirement and a list of one or more WTRUs to send the NTZ configuration information, wherein the list of the one or more WTRUs comprises the WTRU; and
receive an NTZ management response that indicates that the NTZ configuration information was provided to the WTRU.

29. The WTRU of claim 21, wherein the processor is further configured to send the configuration information to a lower layer of the WTRU using a command.

30. The WTRU of claim 21, wherein the processor is further configured to:
send an indication that the WTRU will be subject to NTZ enforcement; and
deactivate a service for the WTRU while the WTRU is subject to NTZ enforcement.

31. A method performed by a wireless transmit/receive unit (WTRU), the method comprising:
determining non-transmit zone (NTZ) configuration information;
determining that the WTRU is approaching an NTZ area;
sending, to a network node, a first notification message that indicates that the WTRU is approaching the NTZ area and a first time associated with entering the NTZ area;
applying an NTZ enforcement based on the NTZ configuration information upon entering the NTZ area;
determining a second time associated with the WTRU leaving the NTZ area; and
sending, to the network node, a second notification message indicating a second time associated with leaving the NTZ area.

32. The method of claim 31, wherein determining the NTZ configuration information comprises sending a registration request message to the network node, wherein the registration request message indicates an NTZ support capability.

33. The method of claim 31, wherein determining the NTZ configuration information comprises sending a request message to the network node, wherein the request message indicates a request for an NTZ policy from the network node.

34. The method of claim 31, wherein the method further comprises sending an NTZ configuration response message to the network node, wherein the NTZ configuration response message indicates that the NTZ configuration information was received.

35. The method of claim 34, wherein the network node is associated with NTZ enforcement, wherein determining the NTZ configuration information comprises receiving a configuration message from the network node, and wherein the configuration message indicates at least one of the NTZ configuration information, an identifier associated with the WTRU, an identifier associated with a UAV, a cell in which NTZ enforcement applies, an NTZ area, a transition area, an NTZ policy, a restricted frequency, or a time period.

36. The method of claim 31, wherein the configuration message further indicates one or more parameters associated with the NTZ enforcement, wherein the one or more parameters comprise at least one of: an indication of transmission blocking within a cell, an indication to reduce transmission power while in a transition area, an indication to search for communication paths permitted for use while in the NTZ area, an indication to update a flight path to avoid the NTZ area, or a condition on which to report cell information associated with the cell.

37. The method of claim 31, wherein the configuration message further indicates one or more parameters associated with the NTZ enforcement, wherein the one or more parameters comprise at least one of: an indication of transmission blocking, full transmission blocking, partial transmission blocking, or occasional transmission blocking.

38. The method of claim 31, wherein the method further comprises:
sending an NTZ management request that indicates an NTZ requirement and a list of one or more WTRUs to send the NTZ configuration information, wherein the list of the one or more WTRUs comprises the WTRU; and
receiving an NTZ management response that indicates that the NTZ configuration information was provided to the WTRU.

39. The method of claim 31, wherein the method further comprises sending the configuration information to a lower layer of the WTRU using a command.

40. The method of claim 31, wherein the method further comprises:
sending an indication that the WTRU will be subject to NTZ enforcement; and
deactivating a service for the WTRU while the WTRU is subject to NTZ enforcement.
